(19) United States
(12) Patent Application Publication
(10) Pub. No.: US 2026/0318522 A1
(43) Pub. Date: Oct. 15, 2026

(54) LIGHT MODULE

(71) Applicant: SIGNIFY HOLDING B.V., EINDHOVEN (NL)

(72) Inventor: PETER JOHANNES MARTINUS BUKKEMS, DEURNE (NL)

(21) Appl. No.: 19/481,029

(22) PCT Filed: Apr. 18, 2024
(86) PCT No.: PCT/EP2024/060544

§ 371 Date: Nov. 3, 2025

(30) Foreign Application Priority Data
May 4, 2023 (EP) 23171493.2
May 4, 2023 (EP) 23171593.9

(51) Int. Cl. F21V 23/06; F21S 8/02; F21V 17/06; F21V 23/00; F21Y 105/16; F21Y 115/10

(52) U.S. Cl. CPC F21V 23/06; F21S 8/02; F21V 17/06; F21V 23/002; F21V 23/003; F21Y 2105/16; F21Y 2115/10

(57) ABSTRACT

A light module (120) is provided. The light module comprises a plurality of light emitting diodes (130), LEDs, a carrier (150) arranged to electrically support the LEDs, wherein the LEDs are arranged on a first side (155) of the carrier, a first connector element (170) arranged on a second side (165) of the carrier, opposite the first side of the carrier, wherein the first connector element comprises a fastening element (180) arranged to extend around a portion (210) of an edge (220) of the carrier, and an electrical connector arrangement (230) arranged to electrically support the carrier, wherein the electrical connector arrangement comprises a second connector element (175) releasably attachable to the first connector element.

### FIELD OF THE INVENTION

The present invention generally relates to light modules. More specifically, the present invention is related to light modules comprising light emitting diodes, LEDs.

### BACKGROUND OF THE INVENTION

The use of light emitting diodes (LED) for illumination purposes continues to attract attention. Compared to incandescent lamps, fluorescent lamps, neon tube lamps, etc., LEDs provide numerous advantages such as a longer operational life, a reduced power consumption, and an increased efficiency related to the ratio between light energy and heat energy.

There is currently also a large interest and need for lighting arrangements or luminaires which are convenient in their constructions, as it is desirable to a provide a robust assembly, convenient removal and/or re-installation of parts or components of the lighting arrangements or luminaires. More specifically, recessed lighting arrangements or luminaires, which may be arranged in offices, homes, stores, etc., may comprise multiple light modules attached to a back plate. For lighting devices of this kind, it is desirable that the individual light modules can be easily removed and re-installed, and that an installation or service of one or more components from the front side and/or the back side of the lighting device is facilitated.

It should be noted that the result of conveniently constructed lighting arrangements or luminaires encompasses an increased energy efficiency and sustainability. More specifically, the possibility to repair and upgrade luminaires significantly increases the sustainability, and a modular design of the luminaires enables an easy replacement of luminaire parts or components thereof.

Prior art lighting arrangements, aiming to provide at least some of the above-mentioned advantages, are often complex and inconvenient in their constructions. Due to these deficiencies, they are consequently not able to achieve the sought energy efficiency and sustainability of the lighting arrangements.

Hence, it is an object of the present invention to provide a lighting arrangement or device which is convenient and non-complex in its structure, which consequently also is energy efficient and sustainable.

### SUMMARY OF THE INVENTION

It is of interest to provide a lighting arrangement or device which is convenient and non-complex in its construction or structure, resulting in an increased energy efficiency and sustainability of the lighting arrangement of luminaire due to a facilitated assembly, as well as removal, repair and re-installation operations.

This and other objects are achieved by providing a light module having the features in the independent claim. Preferred embodiments are defined in the dependent claims.

Hence, according to the first aspect of the present invention, there is provided a light module.

The light module comprises a carrier having a first side and a second side opposite the first side, and a plurality of light emitting diodes, LEDs, arranged on the first side of the carrier and electrically connected to the carrier.

The light module further comprises a first connector element arranged on the second side of the carrier, wherein the first connector element comprises a fastening element.

The light module further comprises an electrical connector arrangement electrically connectable to the carrier and comprising a second connector element releasably attachable to the first connector element.

The carrier may comprise a mounting plate and a foil arranged on the mounting plate, wherein the foil comprises electrical tracks connecting the plurality of LEDs to the first connector element through a fastening element, and wherein the fastening element is an extension tab of the foil. The extension tab has a semi-circular or arched form extending around a portion of an edge of the carrier, and the first connector element is fastened to the second side of the carrier to maintain the semi-circular or arched form of the extension tab.

A method for assembling the light module according to the first aspect comprises the step of providing a carrier having a first side and a second side opposite the first side. The method further comprises the step of arranging a plurality of light emitting diodes, LEDs, on the first side of the carrier for electrical connection to the carrier. The method further comprises the step of arranging a first connector element on the second side of the carrier, wherein the first connector element comprises a fastening element. The method further comprises the step of extending the fastening element around a portion of an edge of the carrier. The method further comprises the step of providing an electrical connector arrangement electrically connectable to the carrier, wherein the electrical connector arrangement comprises a second connector element. The method further comprises the step of attaching the second connector element to the first connector element.

Thus, the present invention is based on the idea of a light module which provides a robust and reliable connection of an electrical connector arrangement for electrical connection to the carrier, and accordingly, to the LEDs. Consequently, damage to the light module component(s), such as the carrier, is hereby mitigated. Furthermore, the first and second connector elements, which are to be attached, are provided on a back side of the carrier, thereby preventing interference with any optical component(s) of the light module.

It should be noted that the first connector element may be rigidly fastened to the carrier, thereby protecting the fastening element which extends around the carrier. Consequently, the present invention is advantageous in that a robust and reliable light module is provided.

The present invention is further advantageous in that the first connector arrangement is arranged on the back side (second side) of the carrier, and the (bent) fastening element may be kept within the light module front face dimensions and design to prevent breakage of the fastening element. The first connector element may furthermore be used to create additional distance and fixation to a luminaire housing (e.g. a back plate) of a luminaire.

The present invention is further advantageous in that due to its improved efficiencies, and consequently, thermal load, it is possible to arrange components directly on the back side of the carrier. This enables lower building heights of the light module and a relatively short thermal path. Furthermore, as the first connector element is provided on the second (back) side of the carrier, other features and component(s) may be provided on the second (back) side.

The present invention is further advantageous by the arrangement of the fastening element which extends around the carrier. This results in a facilitated replacement of the carrier, which in turn facilitates operations related to replacement, repair, mounting and de-mounting of the light module.

The present invention is further advantageous by the versatility of the fastening element which extends around the carrier. More specifically, the light module may be provided with a customized size (radius), dependent on e.g. the length of the fastening element, the thickness of the carrier, etc.

The present invention is advantageous in that its convenience and non-complexity leads to a simplified maintenance, repair, mounting and/or de-mounting of the light module. The present invention is consequently advantageous in that the light module provides a cost-and time efficiency with respect to service operations. Furthermore, as the light module is particularly easy and convenient to repair and maintain, it has a longer service life compared to other lighting arrangements in the prior art, thereby even further contributing to the sustainability aspect of the luminaire.

The present invention is further advantageous in that the convenience of the light module implies a cost-efficient arrangement as such, e.g. concerning the bill of materials.

It will be appreciated that the light module of the present invention comprises relatively few components. The relatively low number of components is advantageous in that the light module is relatively inexpensive to fabricate, and that its production may be conducted in a more environmentally friendly manner compared to prior art products. Moreover, the relatively low number of components of the light module implies an easier recycling, especially compared to devices or arrangements comprising a relatively high number of components which impede an easy disassembling and/or recycling operation.

The light module comprises a carrier. By “carrier”, it is here meant a substrate, or the like, arranged for a supply of (electrical) power to the LEDs. The carrier has a first side and a second side, opposite the first side. Hence, the carrier may be relatively flat, with two opposite sides, constituting first and second sides of the carrier. The LEDs are arranged on the first side of the carrier and are electrically connected to the carrier. The light module further comprises a first connector element arranged on the second side (back side) of the carrier. The first connector element comprises a fastening element arranged to extend around a portion of an edge of the carrier. By “fastening element”, it is here meant substantially any element arranged or configured to fastening, attachment, or the like. The fastening element is arranged to extend around a portion of an edge of the carrier, i.e. the edge between the first and second sides of the carrier. The light module further comprises an electrical connector arrangement electrically connectable to the carrier. By “electrical connector”, it is here meant substantially any connector (arrangement) arranged or configured to be electrically connected to the carrier, i.e. to provide, supply and/or support the carrier with (electrical) power. The electrical connector arrangement comprises a second connector element releasably attachable to the first connector element. By “releasably attachable”, it is here meant that the first and second connector elements are (mechanically) connectable in a releasable manner.

According to an embodiment of the present invention, the carrier comprises a mounting plate, and a foil arranged on the mounting plate, wherein the foil comprises electrical tracks connecting the plurality of LEDs to the first connector element. It should be noted that rigid printed circuit boards, PCB, may allow for a relatively easy board soldering, whereas the operation for a printed electronics board is more challenging. The present embodiment is therefore advantageous by the foil, onto which tracks are printed, and the arrangement or attachment of the foil on the mounting plate.

According to an embodiment of the present invention, the electrical connector arrangement further comprises an electrical cable connected to the second connector element. The present embodiment is advantageous in that the electrical connector arrangement may guide the electrical cable, leading to an even more conveniently structured light module.

According to an embodiment of the present invention, the electrical cable may be arranged to a side of the carrier. The present embodiment is further advantageous in that a flexible positioning and a strain relief may be provided to the light module.

According to an embodiment of the present invention, the fastening element may have an arched form extending around the portion of the edge of the carrier. By the term “arched”, it is here meant that the fastening element has a curved or bent shape. For example, the fastening element may have a semi-circular cross section.

According to an embodiment of the present invention, the first connector element may be fastened on the second side of the carrier. The first connector element may, according to an example, be fastened on the second side of the carrier by an adhesive. By “adhesive”, it is here meant substantially any (fastening) adhesive such as a glue, hot melt, or the like. The first connector element may, according to another example, be fastened on the second side of the carrier by substantially any other (mechanical) fastening arrangement or mechanism, such as a click mechanism, screw(s), etc. The present embodiment is advantageous in that the first connector element is rigidly fixed or fastened to the second side of the carrier, thereby even further contributing to the robustness of the light module.

According to an embodiment of the present invention, the light module may further comprise a click mechanism, wherein the first connector element is releasably attachable to the second side of the carrier via the click mechanism. By “click mechanism”, it is here meant any fitting connection, such as a snap connection or the like. For example, the click mechanism may comprise male connector(s) and correspondingly fitting female connector(s). The present embodiment is advantageous in that the releasable attachment or fastening of the first connector element to the second side of the carrier is particularly convenient, intuitive, easy and efficient.

According to an embodiment of the present invention, the carrier may have a length, L, and wherein the first connector element is arranged at a length, P, of the carrier, wherein 0.45·L<P<0.55·L. Hence, the first connector element is arranged at a central position, or at least at an approximately central position, of the carrier. In other words, the first connector element is arranged at the (at least approximate) middle of the carrier. The present embodiment is advantageous for reasons of string balancing. The present embodiment is further advantageous in that the string resistance may be significantly reduced by the first connector element being centrally positioned in relation to the length of the carrier. It should be noted that a relatively low string resistance is highly desirable for printed tracks on the foil of the carrier.

According to an embodiment of the present invention, the first connector element and the second connector element comprise a mechanism for mating attachment.

The present embodiment is advantageous in that the mechanism for mating attachment provides a releasable attachment or connection between the first and second connector element which is easy and convenient in its operation.

According to an embodiment of the present invention, the mechanism for mating attachment may be a click mechanism. The present embodiment is advantageous in that the click mechanism between the first and second connector elements is particularly convenient, intuitive, easy and efficient.

According to an embodiment of the present invention, the light module may further comprise a lens arranged to optically influence light emitted from the plurality of LEDs of the light module.

Further objectives of, features of, and advantages with, the present invention will become apparent when studying the following detailed disclosure, the drawings and the appended claims. Those skilled in the art will realize that different features of the present invention can be combined to create embodiments other than those described in the following.

### BRIEF DESCRIPTION OF THE DRAWINGS

This and other aspects of the present invention will now be described in more detail, with reference to the appended drawings showing embodiment(s) of the invention.

FIG. 1 schematically shows a luminaire according to an exemplifying embodiment of the present invention,

FIG. 2 schematically shows a light module according to an exemplifying embodiment of the present invention,

FIG. 3 schematically shows a portion of a light module according to an exemplifying embodiment of the present invention,

FIG. 4 schematically shows a luminaire according to an exemplifying embodiment of the present invention, and

FIG. 5 schematically shows a method for assembling a luminaire.

### DETAILED DESCRIPTION

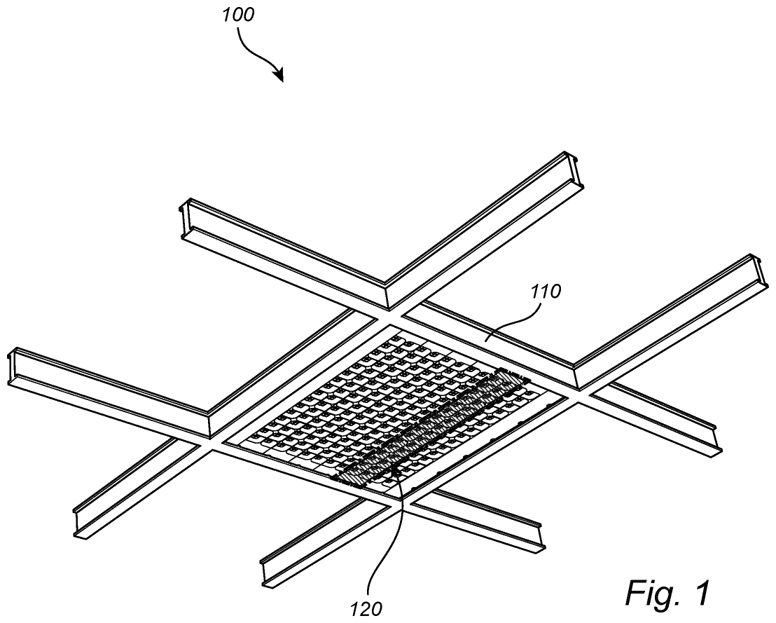

FIG. 1 schematically shows a luminaire 100 according to an exemplifying embodiment of the present invention. The luminaire 100 comprises a luminaire housing 110.

The luminaire housing 110 may be a frame element, a plate element, a back plate, or the like. The luminaire 100 further comprises at least one light module 120 attachable to the luminaire housing 110. The light module 120, comprising a plurality of light emitting diodes, LEDs, may furthermore comprise optical means such as lenses, or the like. The luminaire 100 as exemplified in FIG. 1 may be arranged in a recess of a wall and/or a ceiling.

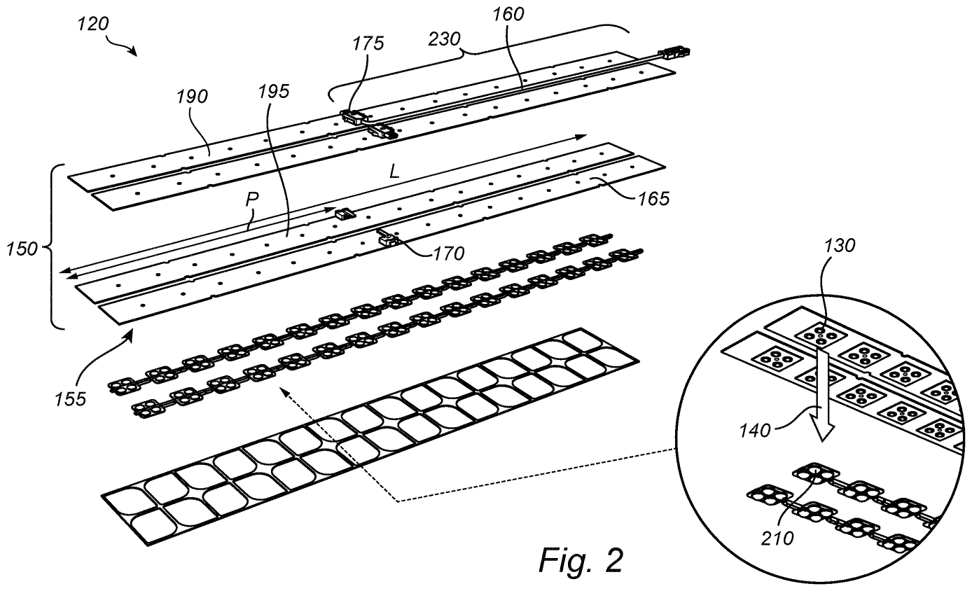

FIG. 2 schematically shows a light module 120 according to an exemplifying embodiment of the present invention. The light module 120 comprises a carrier 150. The carrier 150 is exemplified as a support (structure), substrate, or the like. More specifically, and according to the example of FIG. 2, the carrier 150 comprises a mounting plate 190, wherein the mounting plate 190 may be rigid. The mounting plate 190 may be made of a metal, such as aluminum (Al). The carrier 150 further comprises a foil 195 arranged on the mounting plate 190. The foil 195, which may comprise polyethylene terephthalate (PET), comprises electrical tracks.

The light module 120 further comprises a plurality of LEDs 130 arranged to emit light 140 during operation. The LEDs 130 are arranged on a first side 155 of the carrier 150.

The light module 120 further comprises a lens 210 arranged to optically influence the light 140 emitted from the LEDs 130.

The light module 120 further comprises a first connector element 170 arranged on a second side 165 of the carrier 150, opposite the first side 155 of the carrier 150. The first connector element 170 may be arranged at a central (length) position of the carrier 150. For example, in case the carrier 150 has a length, L, the first connector element 170 is arranged at a length, P, of the carrier 150, wherein 0.45·L<P<0.55·L.

The electrical tracks of the foil 195 connect the plurality of LEDs 130 to the first connector element 170.

The light module 120 further comprises an electrical connector arrangement 230 electrically connectable to the carrier 150. The electrical connector arrangement 230 comprises a second connector element 175 (here shown as a pair of second connector elements 175) releasably attachable to the first connector element 170. The electrical connector arrangement 230 further comprises an electrical cable 160 connected to the second connector element(s) 175.

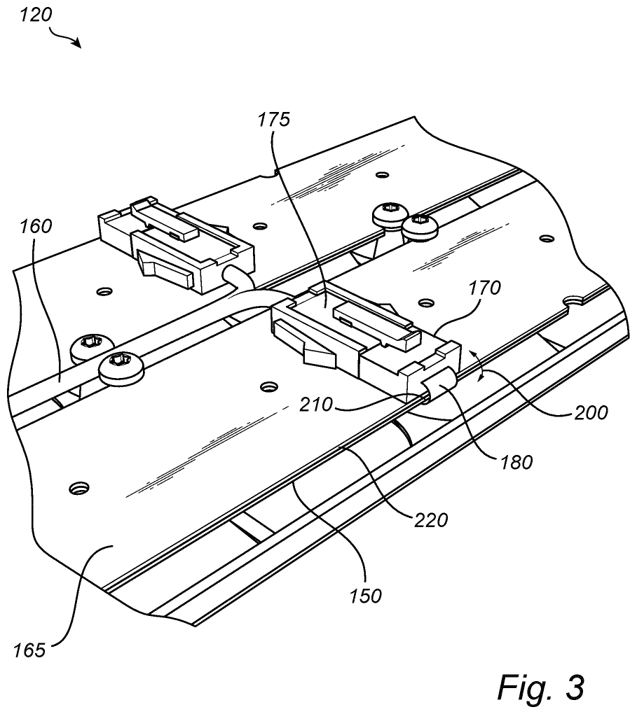

FIG. 3 schematically shows a portion of a light module 120 according to an exemplifying embodiment of the present invention. FIG. 3 shows the second (back) side 165 of the carrier 150 upon which the first connector element 170 is arranged. The first connector element 170 may be fastened on the second side 165 of the carrier 150 by an adhesive. Alternatively, the first connector element 170 may be releasably attachable to the second side 165 of the carrier 150 via a click mechanism. The first connector element 170 comprises a fastening element 180 arranged to extend around a portion 210 of an edge 220 of the carrier 150.

Here, the carrier 150 comprises a mounting plate and a foil arranged on the mounting plate, and the fastening element 180 is exemplified as an extension tab of the foil, which is bent around the edge 220 of the carrier 150.

The fastening element 180, in the form of an extension tab of the foil, has a semi-circular or arched form 200 extending around the portion 210 of the edge 220 of the carrier 150. The radius of the fastening element 180 may be proportional to the thickness of the carrier 150. The radius of the fastening element 180 may, for example, be larger than 1 mm, or larger than 3 mm.

The extension tab of the foil may be bent around the edge 220 of the carrier 150 such that the bent is kept within the front face dimensions of the light module 120.

The extension tab may have a bending radius that is such as to prevent breakage of the extension tab. To obtain and maintain such a desired bending radius, the first connector element 170 may be fixed to the second side 165 of the carrier 150.

The electrical connector arrangement 230 as shown in FIG. 2 comprises the electrical cable(s) 160 as indicated in FIG. 3, which are arranged at (along) the side of the carrier 150. The second connector element 175 of the electrical connector arrangement 230 as shown in FIG. 2 is attached to the first connector element 170 in FIG. 3, e.g. via a click mechanism.

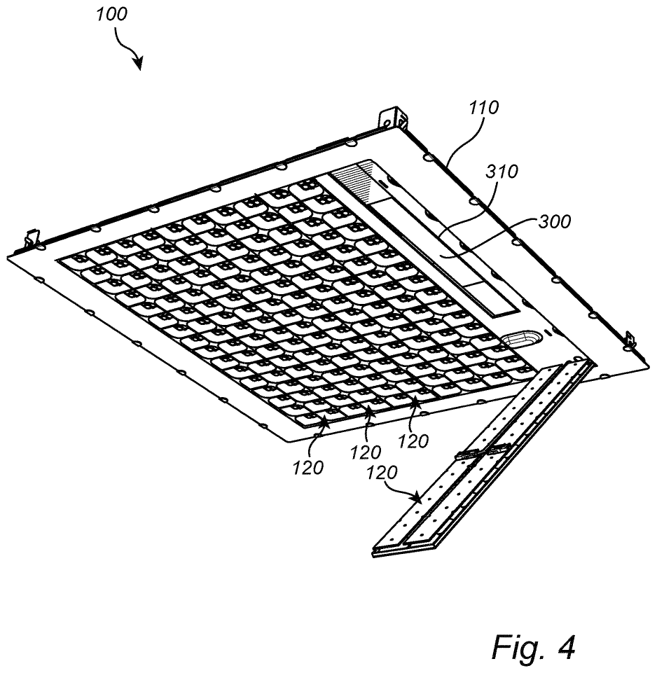

FIG. 4 schematically shows a luminaire 100 according to an exemplifying embodiment of the present invention. The luminaire 100 comprises a plurality of light modules 120. One of the light modules 120 is shown in the detached mode, i.e. that the light module 120 is separated from the luminaire housing 110 of the luminaire 100. The other light modules 120 adopt the first state of the attached mode, whereby the light modules 120 abut the luminaire housing 110 or are arranged in a close vicinity of the luminaire housing 110. The luminaire 100 as exemplified in FIG. 4 comprises a driver 300 arranged to supply electrical power to the light module 120. The luminaire housing 110 comprises an accommodation 310 (e.g. a cavity) arranged to accommodate the driver 300. The light module 120 is arranged to cover the accommodation 310 in the attached mode, whereas in the detached mode, the accommodation 310 is accessible from a front side of the luminaire 100.

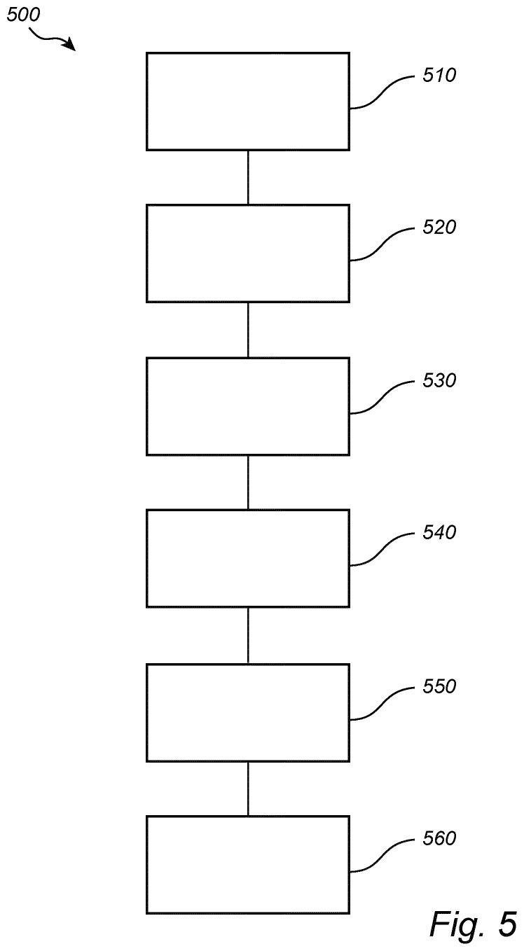

FIG. 5 schematically shows a flow chart for a method 500. The method 500 comprises the step of providing 510 a carrier having a first side and a second side opposite the first side. The method 500 further comprises the step of arranging 520 a plurality of LEDs on the first side of the carrier for electrical connection to the carrier. The method 500 further comprises the step of arranging 530 a first connector element on the second side of the carrier, wherein the first connector element comprises a fastening element. The method 500 further comprises the step of extending 540 the fastening element around a portion of an edge of the carrier. The method 500 further comprises the step of providing 550 an electrical connector arrangement electrically connectable to the carrier, wherein the electrical connector arrangement comprises a second connector element. The method 500 further comprises the step of attaching 560 the second connector element to the first connector element.

The person skilled in the art realizes that the present invention by no means is limited to the preferred embodiments described above. On the contrary, many modifications and variations are possible within the scope of the appended claims. For example, one or more of the carrier 150, the first connector element 170, the second connector element 175, etc., may have different shapes, dimensions and/or sizes than those depicted/described.

1. A light module, comprising:
a carrier having a first side and a second side opposite the first side,
a plurality of light emitting diodes, LEDs arranged on the first side of the carrier and electrically connected to the carrier,
a first connector element arranged on the second side of the carrier, the first connector element comprising a fastening element, and
an electrical connector arrangement electrically connectable to the carrier and comprising a second connector element releasably attachable to the first connector element,
wherein the carrier comprises a mounting plate and a foil arranged on the mounting plate,
wherein the foil comprises electrical tracks connecting the plurality of LEDs to the first connector element through a fastening element,
wherein the fastening element is an extension tab of the foil, the extension tab having a semi-circular or arched form extending around a portion of an edge of the carrier, and
wherein the first connector element is fastened to the second side of the carrier to maintain the semi-circular or arched form of the extension tab.

2. The light module according to claim 1, wherein the electrical connector arrangement further comprises an electrical cable connected to the second connector element.

3. The light module according to claim 2, wherein the electrical cable is arranged to a side of the carrier.

4. The light module according to claim 1, further comprising a click mechanism, wherein the first connector element is releasably attachable to the second side of the carrier via the click mechanism.

5. The light module according to claim 1, wherein the carrier has a length, L, and wherein the first connector element is arranged at a length, P, of the carrier, wherein 0.45·L<P<0.55·L.

6. The light module according to claim 1, wherein the first connector element and the second connector element comprise a mechanism for mating attachment.

7. The light module according to claim 6, wherein the mechanism for mating attachment is a click mechanism.

8. The light module according to claim 1, further comprising a lens arranged to optically influence light emitted from the plurality of LEDs of the light module.

9. A luminaire comprising a luminaire housing and a light module according to claim 1, wherein the light module is attachable to the luminaire housing.

10. The luminaire according to claim 9, further comprising a driver arranged to supply electrical power to the light module, wherein the luminaire housing comprises an accommodation arranged to accommodate the driver, wherein the light module is arranged to cover the accommodation, and wherein the accommodation is accessible from a front side of the luminaire.

11. A luminaire arrangement comprising the luminaire according to claim 9, wherein the luminaire arrangement further comprises at least one of a wall and a ceiling, the at least one of a wall and a ceiling comprising a recess, and wherein the luminaire is arranged in the recess.
